(19) United States
(12) Patent Application Publication
(10) Pub. No.: US 2018/0282121 A1
(43) Pub. Date: Oct. 4, 2018

(54) METHOD AND ARRANGEMENT FOR TESTING THE CAR STRUCTURES OF AN ELEVATOR AND/OR FOR ADJUSTING A LOAD WEIGHING DEVICE

(71) Applicant: Kone Corporation, Helsinki (FI)

(72) Inventors: Markku Haapaniemi, Helsinki (FI); Ari Kattainen, Helsinki (FI)

(73) Assignee: Kone Corporation, Helsinki (FI)

(21) Appl. No.: 16/002,073

(22) Filed: Jun. 7, 2018

Related U.S. Application Data
(63) Continuation of application No. PCT/FI2015/050858, filed on Dec. 7, 2015.

(51) Int. Cl. B66B 5/00; B66B 1/34; G01L 5/04; G01G 19/14

(52) U.S. Cl. CPC B66B 5/0087; G01G 19/14; G01L 5/04; B66B 1/3476

(57) ABSTRACT

The object of the invention is a method and an arrangement for testing the car structures of an elevator and for adjusting a load-weighing device in an elevator provided with a load-weighing device, in which elevator the elevator car is adapted to travel in the elevator hoistway via one or more traction members and suspension members that are separated from each other. For testing the car structures of an elevator and for adjusting a load-weighing device the elevator car is held in its position with a separate arresting means, which is connected to a measuring means measuring tensile stress, and the elevator car is driven upwards with the own hoisting machine of the elevator while at the same time measuring with the measuring means the tensile stress produced in the arresting means.

This application is a continuation of PCT International Application No. PCT/FI2015/050858 which has an International filing date of Dec. 7, 2015, the entire contents of which are incorporated herein by reference.

The object of the present invention is a method as presented in the preamble of claim 1 and an arrangement as presented in the preamble of claim 13 for testing the car structures of an elevator and/or for adjusting a load-weighing device.

Testing the endurance of the strengths of the car structures of an elevator and adjusting the load-weighing device before taking the elevator into use is an important procedure from the viewpoint of the operation of the elevator, because the endurance of the car structure during operation can thus be tested and at the same time the effect of manufacturing differences between load-weighing sensors can be eliminated, in which case the load-weighing device of the elevator can be made display precisely correctly. In solutions known in the art the load-weighing devices of elevators are generally calibrated by means of test weights of known masses. In this case, for example, the elevator car of an elevator having a rated load of 1600 kg is loaded with at least 800 kg of test weights for the calibration of the load-weighing device of the elevator. By the aid of test weights of known masses, calibration of a sensor of the load-weighing device of an elevator can be performed accurately, but a drawback is the large amount of work and the awkward transport arrangements for heavy test weights. A means of transport that is sufficiently large is needed for transporting test weights weighing e.g. 800 kg. Just the transportation and transfer of the test weights in this case easily doubles the amount of work time needed for calibration, in which case the calibration costs also increase. In addition, when testing the strengths of structures even larger test weights are often needed, which are even more awkward to handle.

Since test weights are awkward and dangerous to use, methods replacing their use have been developed. One method known in the art is to press the floor of an elevator car that has stopped at a floor level from the floor level via the open door with a separate lever-type testing device. One problem in this case is possible damaging of the finished floor covering of the elevator car, because the compression force needed against the floor is high.

European patent no. EP2393746B1 presents one known solution for performing a loading test of an elevator. According to the aforementioned solution, an apparatus implementing a loading test is fastened to the counterweight of the elevator in such a way that the apparatus is connected at its top end to the bottom end of the counterweight and at its bottom end e.g. to the base of the elevator hoistway. The apparatus comprises its own actuator that produces tensile stress, by means of which the loading test is performed. This actuator, however, is a more complex and more expensive solution than the solution according to the present invention.

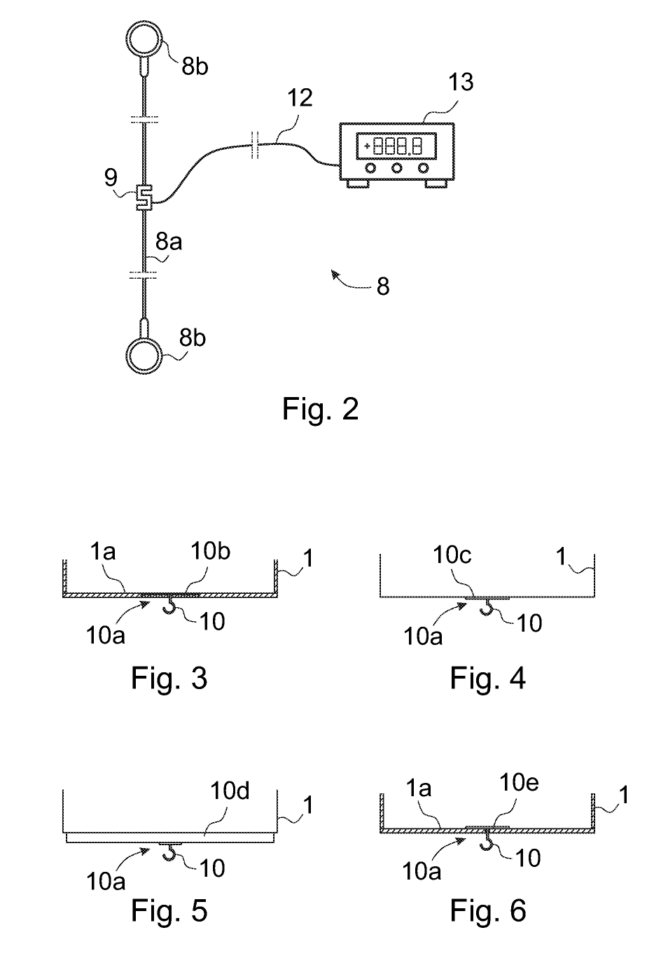

Another known solution for performing a loading test of an elevator without separate test weights is presented in WO publication WO2008071301 A1. In this solution an empty elevator car is locked at its base into position on the elevator guide rails or on the base of the hoistway by means of separate arresting devices, after which the elevator car is driven upwards with the drive motor of the elevator in such a way that tensile stress is exerted in the elevator car and in the arresting devices. The tensile stress acting on the arresting devices is measured and the drive motor is stopped immediately the tensile stress corresponds to a predetermined overload. After this the tensile stress is kept constant for a predetermined period of time. The text section of the publication does not, however, describe in more detail the fixing point of arresting devices on the base of the elevator car, but FIG. 2 of the publication presents the arresting devices being fastened to the bottom corners of the elevator car. With this solution the tensile stress needed e.g. for calibrating the load-weighing device of the elevator can certainly be achieved, but e.g. the endurance of the floor structure of the elevator car cannot be measured with this solution. Another problem is the frictive traction between the traction sheave and the elevator ropes, because if any slipping occurs the measuring does not give the correct result.

The aim of the present invention is to eliminate the aforementioned drawbacks and to achieve an inexpensive, reliable and easy to implement method and arrangement for testing the car structures of an elevator and/or for adjusting a load-weighing device. In addition, one aim is to achieve a method and an arrangement for testing the car structures of an elevator and for adjusting a load-weighing device, in which carryings and transfers of test weights are not needed and in which testing of the car structures of the elevator and adjustment of the load-weighing device are faster and safer to perform than in solutions known in the art. The method according to the invention is characterized by what is disclosed in the characterization part of claim 1. Correspondingly, the arrangement of the invention is characterized by what is disclosed in the characterization part of claim 13. Other embodiments of the invention are characterized by what is disclosed in the other claims.

Some inventive embodiments are also discussed in the descriptive section of the present application. The inventive content of the application can also be defined differently than in the claims presented below. The inventive content may also consist of several separate inventions, especially if the invention is considered in the light of expressions or implicit sub-tasks or from the point of view of advantages or categories of advantages achieved. In this case, some of the attributes contained in the claims below may be superfluous from the point of view of separate inventive concepts. Likewise the different details presented in connection with each embodiment can also be applied in other embodiments. In addition it can be stated that at least some of the subordinate claims can, in at least some situations, be deemed to be inventive in their own right.

The solution according to the invention enables an inexpensive, safe and environmentally friendly solution for measuring the endurance of elevator structures and for adjusting an elevator load-weighing device without needing to use separate test weights that must be transported to the site. In the solution according to the invention the elevator car is adapted to travel in the elevator hoistway via one or more traction members and suspension members that are separated from each other. At least some of the embodiments of the invention are also suitable for use in solutions in which the ropes or belts supporting the elevator car also transmit the movement brought about by the hoisting machine into movement of the elevator car. For testing the car structures of an elevator and for adjusting a load-weighing device, the elevator car is held in its position with a separate arresting means, which is connected to a measuring means measuring tensile stress, and the elevator car is driven upwards with the own hoisting machine of the elevator while at the same time measuring with the measuring means the tensile stress produced in the arresting means. The arresting means is adapted to be connected between the bottom part of the elevator car and a rigid fixing point in the bottom part of the elevator hoistway, for forming tensile stress in the elevator car when driving the elevator car upwards.

An advantageous elevator solution from the standpoint of the invention is one in which the motion brought about by the hoisting machine is transmitted into movement of the elevator car by means of one or more toothed belts. The contact between the toothed belt and the gear wheel that is the traction sheave of the hoisting machine is shape-locked, in which case an error caused by slipping between the traction sheave and the traction member cannot occur in the testing of the car structures or in the adjustment of the load-weighing device.

One advantageous solution is also that the tension produced in the elevator car with the arresting means is exerted from below on the floor structure of the elevator car, e.g. on the structure supporting the floor structure of the elevator car, such as on a beam, framework or other underframe supporting the floor, or on an internal support structure of the floor of the elevator car. A test force can also be exerted on the floor structure of the elevator car via a structure placed on top of the floor of the elevator car. In this case e.g. the belt that is the arresting means can be adapted to pass around the floor of the elevator car by threading the belt from below the elevator car through a gap between the floor and the wall, e.g. through the sill gap, to inside the elevator car and by again threading the belt from the opposite side of the floor through a gap between the floor and the wall back to below the elevator car and by connecting the loop around the floor of the elevator car that has been made in this way to another part of the arresting means, or if the loop is a separate belt it can in this case be connected to a separate arresting means.

One advantage, among others, of the solution according to the invention is that in the solution according to the invention transportation and transfer of test weights are avoided, in which case a performance of the calibration is achieved that is faster and more advantageous in terms of its costs than currently. In addition, the solution according to the invention is simple and operationally reliable, and it is also so light as a device that it can be carried and handled by one person. Another advantage is also that a force corresponding to test weights can be easily transferred to the elevator car, and sufficient accuracy for calibrating the load-weighing device is easily obtained with the calibrating force sensors used in the solution. One advantage is also that the solution according to the invention can be used in different elevator hoistways without fixed installations. Thus the solution according to the invention can be applied in the calibration of all the load-weighing devices in elevator use in different elevators regardless of the different structures of the hoistway systems and load-weighing systems. A further advantage is that with the solution according to the invention the endurance of the elevator structures, including the structural endurance of the floor of the elevator car, is fast, easy and safe to test. Yet a further advantage is that when using an elevator arrangement in which the supporting and the moving of the elevator car are separated from each other and in which movement is effected with a toothed belt solution, instead of with frictive traction, the tensile stress corresponding to loading can be created in the measuring means without fear of errors caused by rope slipping. One advantage is also that the solution according to the invention is environmentally friendly, because heavy test weights do not need to be transported to the elevator worksite and away from it. In this case the environmental impacts caused by transportations of heavy materials are avoided. The invention can be used in elevator solutions in which the machinery bringing about movement of the elevator car is in the bottom part of the elevator hoistway or in the proximity of the bottom part. The invention can also be used in elevator solutions in which the machinery bringing about movement of the elevator car is in the top part of the elevator hoistway or in the proximity of the top part. The invention can also be used in elevator solutions in which the machinery bringing about movement of the elevator car is disposed elsewhere, e.g. in connection with the elevator car and adapted to move with the elevator car.

In the following the invention will be described in more detail by the aid of some examples of its embodiment with reference to the attached simplified drawings, wherein

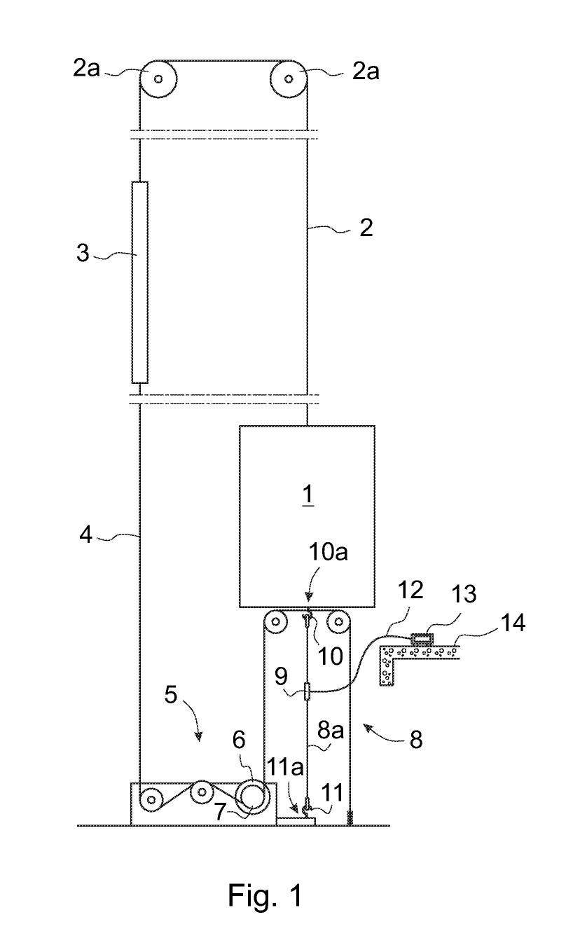

FIG. 1 presents a simplified and diagrammatic side view of one arrangement according to the invention for testing the car structures of an elevator and for adjusting a load-weighing device,

FIG. 2 presents a simplified and diagrammatic view of one partially sectioned apparatus solution suited for use in the method and arrangement according to the invention,

FIG. 3 presents a simplified and sectioned side view of one solution on the bottom part of the elevator car for implementing the method and arrangement according to the invention,

FIG. 4 presents a simplified and sectioned side view of a second solution on the bottom part of the elevator car for implementing the method and arrangement according to the invention,

FIG. 5 presents a simplified and sectioned side view of a third solution on the bottom part of the elevator car for implementing the method and arrangement according to the invention,

FIG. 6 presents a simplified and sectioned side view of yet another solution on the bottom part of the elevator car for implementing the method and arrangement according to the invention,

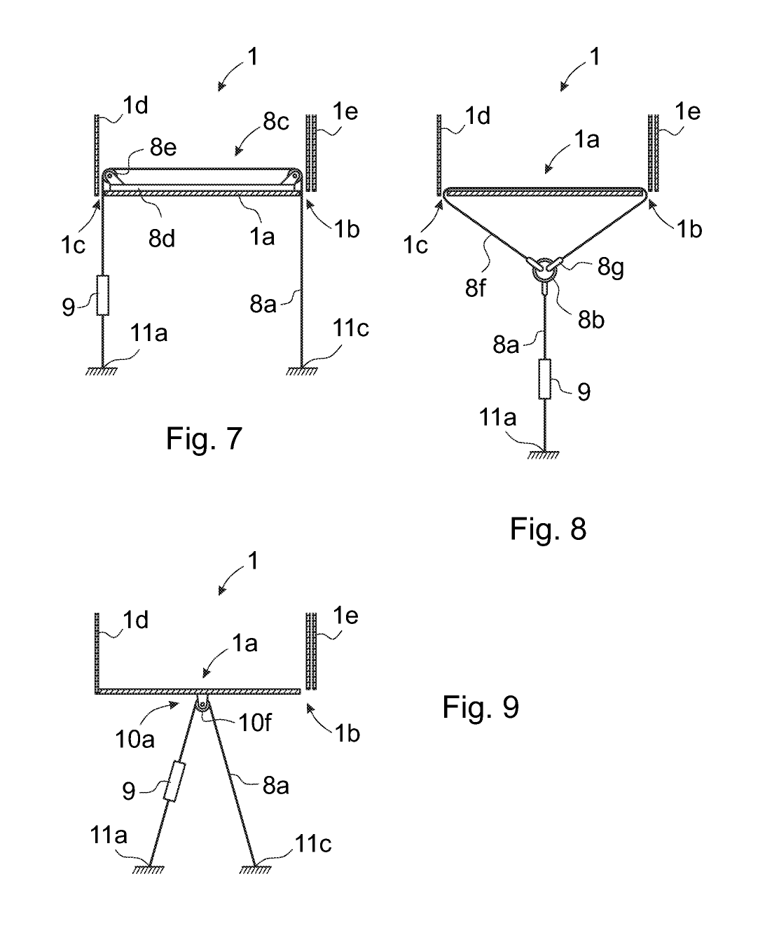

FIG. 7 presents a simplified and sectioned side view of yet another solution on the bottom part of the elevator car for implementing the method and arrangement according to the invention,

FIG. 8 presents a simplified and sectioned side view of yet another solution on the bottom part of the elevator car for implementing the method and arrangement according to the invention,

FIG. 9 presents a simplified and sectioned side view of yet another solution on the bottom part of the elevator car for implementing the method and arrangement according to the invention,

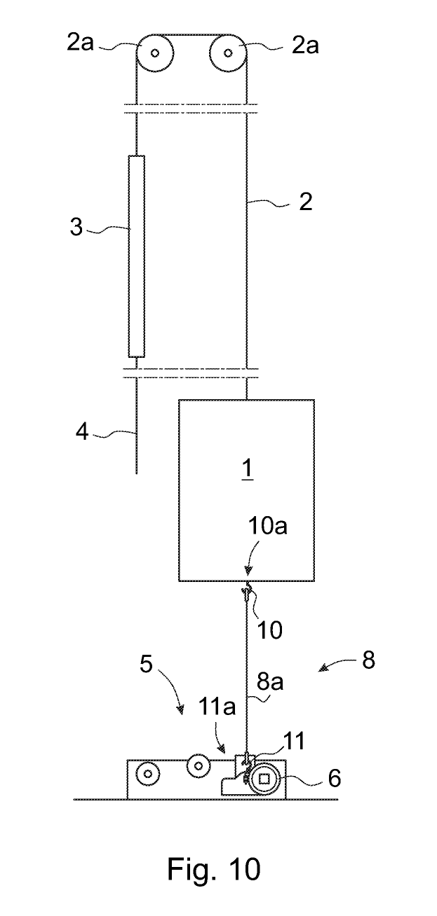

FIG. 10 presents a simplified and diagrammatic side view of a second arrangement according to the invention for testing the car structures of an elevator and for adjusting a load-weighing device,

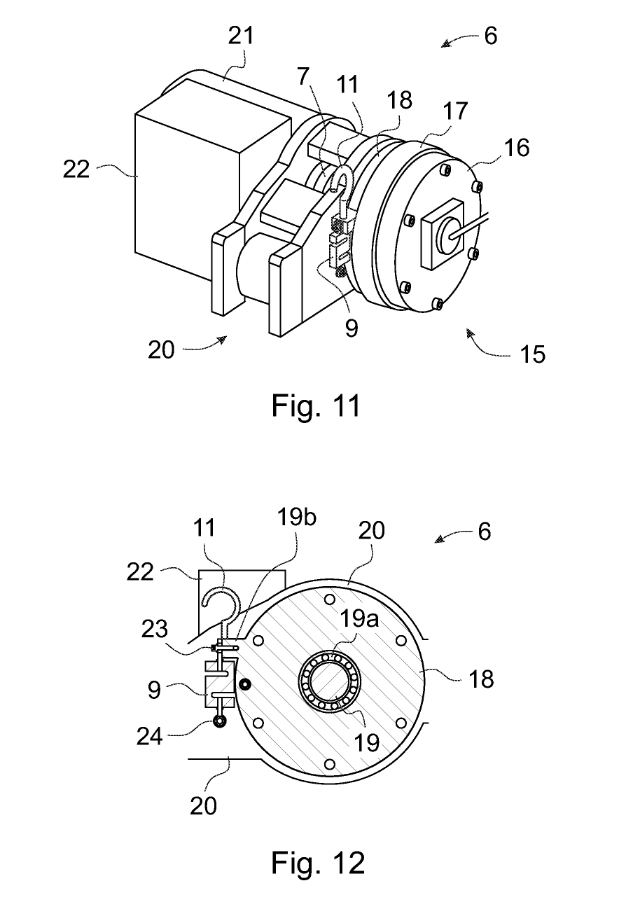

FIG. 11 presents a simplified view obliquely from the side and top of the elevator hoisting machine to be used in the solution according to FIG. 10, and

FIG. 12 presents a partially sectioned hoisting machine according to FIG. 11, as viewed in the direction of the shaft of the hoisting machine of the elevator.

FIG. 1 presents a simplified and diagrammatic view of one arrangement according to the invention for testing the car structures of an elevator and for adjusting a load-weighing device. In the elevator arrangement, the supporting and the moving of the elevator car 1 are separated from each other in such a way that the elevator car 1 is supported with one or more suspension members 2, which are adapted to travel from the elevator car 1 via the diverting pulleys 2a in the top part of the elevator hoistway to the compensating weight or counterweight 3, which is also supported by means of the same suspension members 2. The suspension members 2 can be e.g. belts or ropes.

The moving of the elevator car 1 is effected with the hoisting machine 6 disposed in the machine station 5, a traction member 4 being placed to pass around the traction sheave 7 of which hoisting machine, which traction member is connected between the elevator car 1 and the compensating weight or counterweight 3 to move both simultaneously but in opposite directions. In the solution according to FIG. 1 the traction member 4 is fixed at its first end to the floor of the elevator hoistway, from where it rises upwards and passes around the top of the diverting pulleys mounted on bearings below the elevator car 1, back via the bottom of the traction sheave 7 of the hoisting machine 6 disposed in the bottom part of the elevator hoistway, or on the base of it, after which the traction member 4 ascends, guided by diverting pulleys, to the compensating weight or counterweight 3, to which the second end of the traction member 4 is fixed. The traction member 4 can also be fixed directly to the bottom part of the elevator car 1. In addition, the fixings of the ends of the traction member 4 and the path of passage of the traction member can also be other than what is presented above.

In the method and arrangement according to the invention, i.e. more briefly in the solution according to the invention, a separate measuring apparatus 8 is used, which is connected between a fixing point 10a, which is on the bottom part of the elevator car 1, and a rigid fixing point 11a below the elevator car 1, which fixing point 11a can be on the machine station 5 or e.g. on the base of the elevator hoistway, or also on the guide rails of the elevator. Both fixing points 10a, 11a have e.g. a fastening hook 10, 11 for quick and easy attachment and detachment of the measuring apparatus 8.

The measuring apparatus 8, which is presented in more detail in FIG. 2, comprises at least an arresting means 8a, such as e.g. a steel wire rope or strong belt, a measuring means 9, such as e.g. a load cell or load-weighing cell 9, measuring the tensile stress of the arresting means 8a, and a display device 13, which is connected to the measuring means 9 via a cable 12. At both ends of the arresting means 8a is a loop 8b for connecting the arresting means 8a to the fastening hooks 10 and 11. As a result of the cable 12, the display device 13 can be kept e.g. on a floor level 14 during the testing of the elevator structures and the adjustment of the load-weighing device of the elevator.

The fixing point 10a of the arresting means 8a, the fixing point being on the bottom part of the elevator car 1, is preferably in the center of, or on the center part of, the floor 1a of the elevator car 1, in which case also the endurance of the structure of the floor 1a of the elevator car can be measured with the measuring apparatus 8 without needing to use awkward test weights. FIGS. 3-6 present various solutions according to the invention in the structure of a fixing point 10a. The arresting means 8a, or a belt loop to be fastened to it, can also be passed around the floor of the elevator car through apertures made between the floor and the walls of the elevator car, or through the sill gap of the elevator car and an aperture between the rear wall and floor of the elevator car. FIGS. 7-9 present various solutions according to the invention in which an arresting means 8a, or a separate belt loop to be attached to it, is led to travel around the floor of the elevator car.

In the solution according to FIG. 3 the floor 1a, or at least the center part of it, of the elevator car 1 is strengthened with a reinforcement 11b, which is preferably disposed inside the floor structure and to which the fastening hook 10 is fixed. Correspondingly, in the solution according to FIG. 4 the fastening hook 10 is fixed to a reinforcing plate 10c, which is in turn fixed to the bottom of the elevator car 1, to the center of the base of the elevator car 1. In the solution according to FIG. 5 a support frame or support beam 10d is fixed to the bottom surface of the base of the elevator car 1, to which frame or beam a fastening hook 10 is fixed, and in the solution according to FIG. 6 a hole is made through the floor 1a of the elevator car 1, through which hole a fastening hook 10 is threaded through to the top of the floor surface and is fixed to a support plate 10e disposed on the top surface of the floor 1a. The fixing solutions can also be other than these, but what they all have in common is that the fixing point 10a is situated essentially in the center of, or on the center part of, the floor 1a or the base of the elevator car.

FIGS. 7-9 present a simplified and sectioned view of the bottom part of the elevator car 1. In this case only the bottom part of the door 1e of the car, the bottom part of the rear wall 1d and the floor 1a are presented. In the solutions according to FIGS. 7 and 8 a separate fixing point is not needed on the base of the elevator car, but instead an arresting means 8a, or a separate belt-type retention loop 8f to be attached to it, is passed around the floor 1a of the elevator car from the apertures 1b and 1c, which are situated at the boundary of the floor 1a of the elevator car, either in the wall, in the floor or in both. The first aperture 1b is e.g. the sill clearance of the elevator car and the second aperture 1c is in this case e.g. the aperture between the rear wall 1d and the floor 1a, which aperture is sufficiently large for threading the end of the belt of the retention loop 8f through it. The second aperture 1c is covered during operation, e.g. with a covering strip or corresponding.

In the solution according to FIG. 7 a separate additional support 8c that is provided with rollers 8e is disposed on the floor 1a of the elevator car 1, which support has a frame part 8d, at both ends of which is e.g. one roller 8e, over which the arresting means 8a is led to travel e.g. to inside the elevator car 1 from the second aperture 1c and out of the elevator car from the first aperture 1b. The measuring device 9 in the arresting means 8a is below the elevator car 1, and in this case the first end of the arresting means 8a is fastened to a first rigid fixing point 11a in the elevator hoistway, and the second end is fixed to a second rigid fixing point 11c. The base surface area of the frame part 8d can be of different sizes depending on, inter alia, what kind of loading it is desired to exert on the floor 1a of the elevator car. A small surface area exerts a larger point load on the floor 1a with the same tensile stress than a larger surface area. With an additional support 8c that is smaller in surface area, different points in the floor of the elevator car can also be easily tested.

In the solution according to FIG. 8 a separate belt-type retention loop 8f is disposed around the floor 1a of the elevator car, the retention loop being led to pass e.g. from the second aperture 1c to inside the elevator car 1 and from the first aperture 1b out of the elevator car 1, and is connected, e.g. at its ends provided with hooks 8g, to a loop 8b of the arresting means 8a. An additional support 8c according to FIG. 7 or some separate reinforcement can also be on the floor 1a between the retention loop 8f and the surface of the floor 1a. In addition, instead of a separate retention loop 8f, just the arresting means 8a can also pass around the floor 1a in the same manner.

In the solution according to FIG. 9, instead of a fastening hook 10, a diverting pulley 10f is fixed to the center of, or to the center area of, the floor 1a of the elevator car 1. In this case in the floor structure the fixing solution of the diverting pulley 10f can be any whatsoever fixing solution for a fastening hook 10 presented in FIGS. 3-6, or some other structural solution suited to the purpose. The arresting means 8a is now led to travel from its fixing point 11a of the first end that is in the bottom part of the elevator hoistway over the diverting pulley 10f back to its fixing point 11c of the second end that is in the bottom part of the elevator hoistway.

FIG. 10 presents a simplified and diagrammatic view of a second arrangement, according to the invention, for testing the car structures of an elevator and for adjusting a load-weighing device. In this solution the supporting and moving of the elevator car 1 are implemented in the same manner as in the solution according to FIG. 1. For the sake of clarity the traction member 4 is, however, truncated below compensating weight or counterweight 3 and it is not presented below the elevator car 1 nor in the machine station 5. The difference in this solution with respect to the solution presented by FIG. 1 is only that for measuring the tensile stress of the arresting means 8a a separate measuring device 9 is not needed in the arresting means 8a itself, but instead the measuring means 9 measuring tensile stress is now the brake sensor of the load-weighing apparatus that is in the brake of the elevator machine 6, the brake sensor simultaneously functioning as the load-weighing sensor of the elevator. The measuring means 9 is fixed to the frame flange that is in connection with the brake that is in the elevator machine 6, the frame flange being presented in more detail in connection with FIGS. 8-9. Likewise, a separate display 13 is not necessarily needed or the display 13 can be temporarily fastened to the elevator control center, which is not presented in the figures.

FIGS. 11 and 12 present in more detail the structure of the elevator hoisting machine 6 to be used in the solution according to FIG. 10, which hoisting machine comprises a frame 20, onto one side of which the motor 21 of the elevator is fixed and onto the other side of which frame the brake 15 of the elevator machine is fixed. The frame 20 is fixed to other structures of the elevator or of the building, e.g. to a machine station 5, such as in FIG. 10, or e.g. to the floor of the elevator hoistway. The shaft 19 of the motor 21 is mounted on bearings in the frame 20 and extends through the frame 20 to the brake 15. Also on the shaft 19 is a traction sheave 7 rotating along with the shaft 19.

The brake 15 of the hoisting machine 6 comprises a magnet part 16, an armature plate and a brake disc that are fitted inside an enclosure 17, as well as a frame flange 18, all of which are fitted around the shaft 19 of the hoisting machine 6 in such a way that the brake disc rotating along with the shaft 19 is between the armature plate and the frame flange 18 in the axial direction. The frame flange 18 is mounted on bearings 19a on the shaft 19, which enables the frame flange 18 to stay in its place despite the rotation of the shaft 19. In addition, the frame flange 18 is fixed to the frame 20 via measuring means 9, which measuring means 9 is preferably e.g. an S-shaped model. In normal operation the measuring means 9 is arranged to measure the torque exerted on the frame flange 18 of the brake 15, when the brake 15 is closed. With the same measuring means 9 the tension of the arresting means 8a in the solution according to the invention is measured, when the elevator car 1 is driven upwards in the testing and adjustment phase and the brake 15 is open.

On the frame flange 18 slightly above the center line of the flange and protruding from the outer rim of the flange towards the side is a fixing part 19b, to which the first end, i.e. the top end, of the measuring means 9 is fixed by the aid of a fastening means 23, such as a screw. Correspondingly, the second end, i.e. the bottom end, of the measuring means 9 is fixed to the frame 20 of the hoisting machine 6 by the aid of a fastening means 24, such as a screw.

The shaft 19 of the elevator machine 6 is free to rotate on the bearings 19a of the frame flange 18, when the brake 15 is open. When the brake 15 is closed, the armature plate presses the brake disc from the effect of the brake springs against the frame flange 18, in which case the brake 15 brakes and stops the rotation of the shaft 19. In this case torque is exerted on the frame flange 18, which when the frame flange 18 tries to rotate, in the situation of FIG. 12 clockwise, elongates, via the fixing part 19b of the frame flange 18, the load cell functioning as a measuring means 9. The load of the elevator car 1 in normal operation of the elevator as well as the tensile stress of the arresting means 8a in testing and adjustment use can be calculated from the amount of elongation of the load cell.

In the method and arrangement according to the invention, the endurance of the structures of the elevator and calibration of the load-weighing device are implemented by driving the elevator car 1 first to a suitable floor level, e.g. to the lowermost floor level 14, after which the first end of an arresting means 8a, such as a steel wire rope, holding the elevator car 1 is fixed to the elevator car 1, preferably to the bottom part of the elevator car 1, and the second end of which arresting means 8a is fixed to a machine station 5 that is in the bottom part of, or on the base of, the elevator hoistway, or to some other rigid fixing point 11a that is on the base of the hoistway or in the proximity of the base. After this the elevator car 1 is driven via the traction member 4 and suspension member 2 upwards in such a way that tensile stress is produced in the arresting means 8a. The tensile stress produced is measured with the measuring means 9.

Adjustment of the load-weighing apparatus, i.e. load-weighing device, of the elevator is performed by driving the elevator car 1 upwards in the manner presented above when the arresting means 8a is connected between the elevator car 1 and a rigid fixing point 11a, and by comparing the reading expressed by the display 13 to the reading shown by the load-weighing device of the elevator. The load-weighing device is adjusted after this to precisely the right point in such a way that both the load-weighing device and the display 13 of the measuring device show the same reading.

The endurance of the structures of the elevator car 1 is performed e.g. after the adjustment of the load-weighing device when the arresting means 8a is still connected between the elevator car 1 and a rigid fixing point 11a in such a way that by again driving the elevator car 1 upwards the tensile stress of the arresting means 8a is increased to correspond to 125% of the rated load of the elevator. When the tension is eliminated and the elevator is returned to its normal state, it can be visually checked whether permanent deformations or other damages have occurred in the structures. This testing corresponds to testing according to prior art by loading the elevator car with separate weights.

When the arresting means 8a is firmly fixed to the center of the floor 1a or base of the elevator car 1, the tensile stress produced in the arresting means 8a in a testing situation acts on the center point of the floor 1a, in which case the endurance of the floor 1a of the elevator car 1 can be tested with the same measuring apparatus 8 without the need for awkward separate weights.

It is obvious to the person skilled in the art that the invention is not limited solely to the examples described above, but that it may be varied within the scope of the claims presented below. Thus, for example, the structure of the measuring apparatus may differ from what is presented above.

1. Method for testing the car structures of an elevator and/or for adjusting a load-weighing device in an elevator provided with a load-weighing device, in which elevator the elevator car is adapted to travel in the elevator hoistway via one or more traction members and suspension members that are separated from each other, wherein for testing the car structures of the elevator and/or for adjusting a load-weighing device the elevator car is held in its position with a separate arresting means, which is connected to a measuring means measuring tensile stress, and the elevator car is driven upwards with the own hoisting machine of the elevator while at the same time measuring with the measuring means the tensile stress produced in the arresting means.

2. Method according to claim 1, wherein the tension produced in the elevator car is exerted on the bottom part of the elevator car with the arresting means from below.

3. Method according to claim 1, wherein the tension produced in the elevator car with the arresting means is exerted on the floor structure of the elevator car.

4. Method according to claim 1, wherein the tension produced in the elevator car with the arresting means is exerted on a structure supporting the floor structure of the elevator car, such as on a beam, framework or other underframe supporting the floor.

5. Method according to claim 1, wherein the tension produced in the elevator car with the arresting means is exerted on an internal support structure of the floor of the elevator car.

6. Method according to claim 1, wherein the tension produced in the elevator car with the arresting means is exerted on a support structure on the top surface of the floor of the elevator car.

7. Method according to claim 1, wherein the tension produced in the elevator car with the arresting means is exerted on a separate support structure disposed on the top surface of the floor of the elevator car.

8. Method according to claim 1, wherein the arresting means is connected to the structures of the elevator car on essentially the vertical centerline of the elevator car.

9. Method according to claim 1, wherein the arresting means is connected at its bottom end to a fixing point in the bottom part of the elevator hoistway.

10. Method according to claim 1, wherein the arresting means is connected at its first end to a first fixing point in the bottom part of the elevator hoistway, is led to pass around the top of a diverting pulley disposed on a fixing point that is on a floor structure of the elevator car, and is connected at its second end to a second fixing point that is in the bottom part of the elevator hoistway.

11. Method according to claim 1, wherein the arresting means is connected at its bottom end to a fixing point on the elevator machine station that is in the bottom part of the elevator hoistway.

12. Method according to claim 1, wherein the arresting means is connected at its bottom end to a fixing point on the brake load-weighing device of the elevator and a force measuring means on the brake load-weighing device is used, when the operational brake of the elevator is open, for testing the car structures of the elevator.

13. Arrangement for testing the car structures of an elevator and for adjusting a load-weighing device in an elevator provided with a load-weighing device, in which elevator the elevator car is adapted to travel in the elevator hoistway via one or more traction members and suspension members that are separated from each other, wherein the arrangement comprises a separate arresting means, which is adapted to be connected between the bottom part of the elevator car and a rigid fixing point in the bottom part of the elevator hoistway for forming tensile stress in the elevator car when driving the elevator car upwards.

14. Arrangement according to claim 13, wherein the arresting means is adapted to be connected at its top end to the floor structure of the elevator car to exert tensile stress in the floor structure when driving the elevator car upwards when the arresting means is connected between the elevator car and a rigid fixing point in the bottom part of the elevator hoistway.

15. Arrangement according to claim 13, wherein the arresting means is adapted to be connected at its top end to a fixing point that is on a floor structure of the elevator car and at its bottom end to a fixing point in the bottom part of the elevator hoistway.

16. Arrangement according to claim 13, wherein the arresting means is adapted to be connected at its first end to a first fixing point in the bottom part of the elevator hoistway, to pass around the top of a diverting pulley disposed on a fixing point that is on a floor structure of the elevator car, and to be connected at its second end to a second fixing point that is in the bottom part of the elevator hoistway.

17. Arrangement according to claim 13, wherein the arresting means is adapted to be connected at its top end to a structure supporting the floor structure of the elevator car, such as to a beam, framework or other underframe supporting the floor.

18. Arrangement according to claim 13, wherein the arresting means is adapted to be connected at its top end to an internal support structure of the floor of the elevator car.

19. Arrangement according to claim 13, wherein the arresting means is adapted to be connected at its top end to a support structure on the top surface of the floor of the elevator car.

20. Arrangement according to claim 13, wherein the arresting means is adapted to be connected at its top end to a separate support structure disposed on the top surface of the floor of the elevator car.

21. Arrangement according to claim 13, wherein the arresting means is adapted to be connected at its top end to a separate retention loop wound around the floor of the elevator car, or in that the top end of the arresting means is wound around the floor of the elevator car.

22. Arrangement according to claim 21, wherein in two opposite edges of the floor of the elevator car are apertures for threading the top end of a separate retention loop or arresting means around the top of the floor of the elevator car.

23. Arrangement according to claim 22, wherein the first aperture is the sill clearance of the elevator car and the second aperture is an aperture between the wall opposite the door opening and the floor, either just in the wall, just in the floor or in both.

24. Arrangement according to claim 13, wherein the arresting means is adapted to be connected to the structures of the elevator car on essentially the vertical centerline of the elevator car.

25. Arrangement according to claim 13, wherein the arrangement comprises a force measuring means for measuring the tensile stress forming in the arresting means.

26. Arrangement according to claim 13, wherein the arresting means is adapted to be connected at its bottom end to a fixing point on the elevator machine station that is in the bottom part of the elevator hoistway.

27. Arrangement according to claim 13, wherein the arresting means is adapted to be connected at its bottom end to a fixing point in the brake load-weighing device of the elevator and the force measuring means in the brake load-weighing device is adapted to be used for testing the car structures of the elevator when the operational brake of the elevator is open.

28. Arrangement according to claim 13, wherein the arresting means is a rope-like means, such as a steel wire rope or strong belt, provided with a fastening loop at both of its ends.

29. Arrangement according to claim 13, wherein the arresting means is provided with a force measuring means for measuring the tensile stress forming in the arresting means.

30. Arrangement according to claim 13, wherein the elevator car is driven by means of one or more toothed belts.
